(19) United States
(12) Patent Application Publication
(10) Pub. No.: US 2025/0348762 A1
(43) Pub. Date: Nov. 13, 2025

(54) KNOWLEDGE BASE AND INTERFACE FOR EFFICIENT RESPONSE TO USER QUERIES

(71) Applicant: Palo Alto Networks, Inc., Santa Clara, CA (US)

(72) Inventors: Nilesh Girsh Telang, Sunnyvale, CA (US); Sheng Yang, Santa Clara, CA (US); Tejul Mayank Pandit, Santa Clara, CA (US); Charanraj Thimmisetty, Dublin, CA (US)

(21) Appl. No.: 18/657,129

(22) Filed: May 7, 2024

(51) Int. Cl. G06N 5/04; G06N 5/022

(52) U.S. Cl. CPC G06N 5/04; G06N 5/022

(57) ABSTRACT

A knowledge base is built, maintained, and utilized for responding to user queries. The knowledge base is populated with queries and corresponding answers that have been generated based on prompting a foundation model with documents included in a datastore used for RAG. Embeddings of the queries are generated and stored in the knowledge base with their corresponding query-answer pairs. To manage changes to the documents in the datastore, updates, deletions, and/or additions to documents in the datastore are periodically identified, and the query-answer pairs that are associated with changes to documentation can be updated accordingly. As a support service receives user queries, the support service searches the knowledge base for queries that are sufficiently similar to the user query based on comparing the associated embeddings. The support service generates a response to the user query based on the answer that corresponds to the most similar query in the knowledge base.

### BACKGROUND

The disclosure generally relates to data processing (e.g., CPC subclass G06F) and to computing arrangements based on specific computational models (e.g., CPC subclass G06N).

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a foundational model, and there has been subsequent research in similar Transformer-based sequence modeling. Architecture of a Transformer model typically is a neural network with transformer blocks/layers, which include self-attention layers, feed-forward layers, and normalization layers. The Transformer model learns context and meaning by tracking relationships in sequential data. Some large language models (LLMs) are based on the Transformer architecture. An LLM is “large” because the training parameters are typically in the billions. LLMs can be pre-trained to perform general-purpose tasks or tailored to perform specific tasks. Tailoring of language models can be achieved through various techniques, such as prompt engineering and fine-tuning. For instance, a pre-trained language model can be fine-tuned on a training dataset of examples that pair prompts and responses/predictions. Prompt-tuning and prompt engineering of language models have also been introduced as lightweight alternatives to fine-tuning. Prompt engineering can be leveraged when a smaller dataset is available for tailoring a language model to a particular task (e.g., via few-shot prompting) or when limited computing resources are available. In prompt engineering, additional context may be fed to the language model in prompts that guide the language model as to the desired outputs for the task without retraining the entire language model or changing the weights of the language model.

Applications that use foundation models have combined the use of a foundation model with retrieval augmented generation (RAG). RAG augments a query/prompt with context, in the form of embeddings, from an authoritative data source external to the foundation model. This separation allows for the authoritative data source to be more efficiently updated than updating knowledge of the foundation model and facilitates dynamic augmentation of a prompt with current context for a domain(s) represented by the authoritative data source. The RAG technique generates an embedding(s) from the prompt and retrieves similar embeddings from the authoritative data source. With the prompt and similar embeddings, the foundation model generates a retrieval augmented output that has been shown to be more accurate and context-relevant than without RAG.

### BRIEF DESCRIPTION OF THE DRAWINGS

Embodiments of the disclosure may be better understood by referencing the accompanying drawings.

FIG. 1 is a conceptual diagram of a support service that interfaces with a knowledge base comprising pre-generated query-answer pairs.

FIG. 2 is a conceptual diagram of building a knowledge base of query-answer pairs.

FIG. 3 is a flowchart of example operations for responding to user queries using a knowledge base that stores query-answer pairs previously generated based on a set of documents.

FIG. 4 is a flowchart of example operations for selecting a most similar query to a user query from a set of query-answer pairs retrieved from a knowledge base.

FIG. 5 is a flowchart of example operations for managing changes to a knowledge base based on changes to documents in a datastore.

FIG. 6 is a flowchart of example operations for updating query-answer pairs in a knowledge base based on changes to documents in a datastore.

FIG. 7 depicts an example computer system with a support service and a knowledge base manager.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Organizations have adopted chatbots or other interactive systems that use foundation models with RAG at an increasing rate. RAG poses the challenge that the relevant data stores may be large and frequently updated, such as due to updating, deleting, or adding documents to a datastore used for RAG. Also, latencies associated with the use of foundation models with RAG in customer settings (e.g., chatbot environments) may be high. Techniques for building and maintaining a knowledge base and responding to user queries based on the contents of the knowledge base that overcomes these challenges are disclosed herein.

A knowledge base manager populates the knowledge base with queries and corresponding answers that have been generated based on prompting a foundation model (e.g., an LLM) to generate query-answer pairs based on a set of documents, such as technical support documentation. The knowledge base manager also generates embeddings of the queries and stores the embeddings in the knowledge base with their corresponding query-answer pairs. To manage changes to the documents in the datastore, the knowledge base manager periodically determines whether any of the documents have been modified or if any documents have been added or deleted since the last review of the datastore. Changes to the contents of the datastore, whether due to addition/deletion of documents or modification of existing documents, are identified, and the knowledge base manager can update answers stored in the knowledge base if the change to the available documents substantially alters the answer to a corresponding query.

As user queries are submitted to a support service that interfaces with the knowledge base, the support service searches the knowledge base for one or more queries maintained therein (if any) that are sufficiently similar to the user query based on comparison of the associated embeddings. If multiple queries satisfying a similarity criterion are identified, the support service can prompt a set of foundation models (e.g., a set of LLMs) using a chain of thought to determine which of the queries is most similar to the user query and identifies the query that is selected by a majority of the LLMs as the most similar query. The support service generates a response to the user query based on the answer that corresponds to the most similar query in the knowledge base, thus conserving time and resources since the answer has been precomputed by a foundation model rather than generated in real time based on the user query. The support service and knowledge base interaction can also serve as a caching layer, where queries that cannot be answered using the knowledge base are answered by a foundation model that uses RAG.

### Example Illustrations

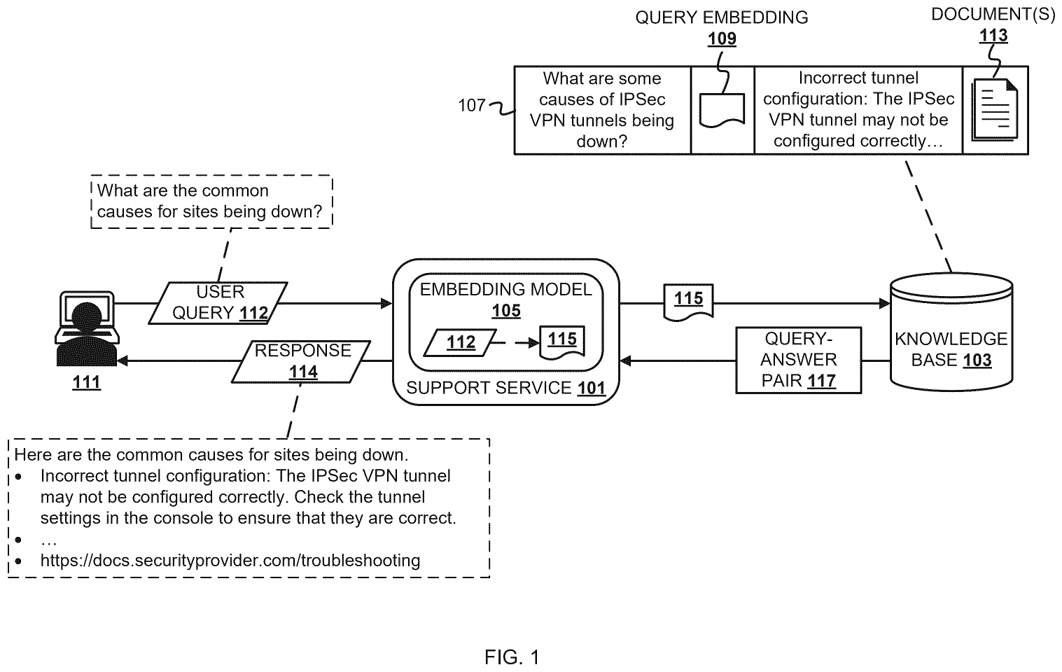

FIG. 1 is a conceptual diagram of a support service that interfaces with a knowledge base comprising pre-generated query-answer pairs. A support service 101 obtains user queries and utilizes a knowledge base 103 to respond to the user queries. The support service 101 provides a live support service to users, such as for technical support or customer assistance. For instance, the support service 101 can comprise a chatbot interface. The knowledge base 103 is a database that stores queries and their corresponding answers that the support service 101 searches as part of responding to user queries. The knowledge base 103 also stores embeddings generated for each query and can provide vector similarity search capabilities. For instance, the knowledge base 103 can comprise a vector database that is indexed by query embeddings. This example depicts a client 111 as communicating with the support service 101.

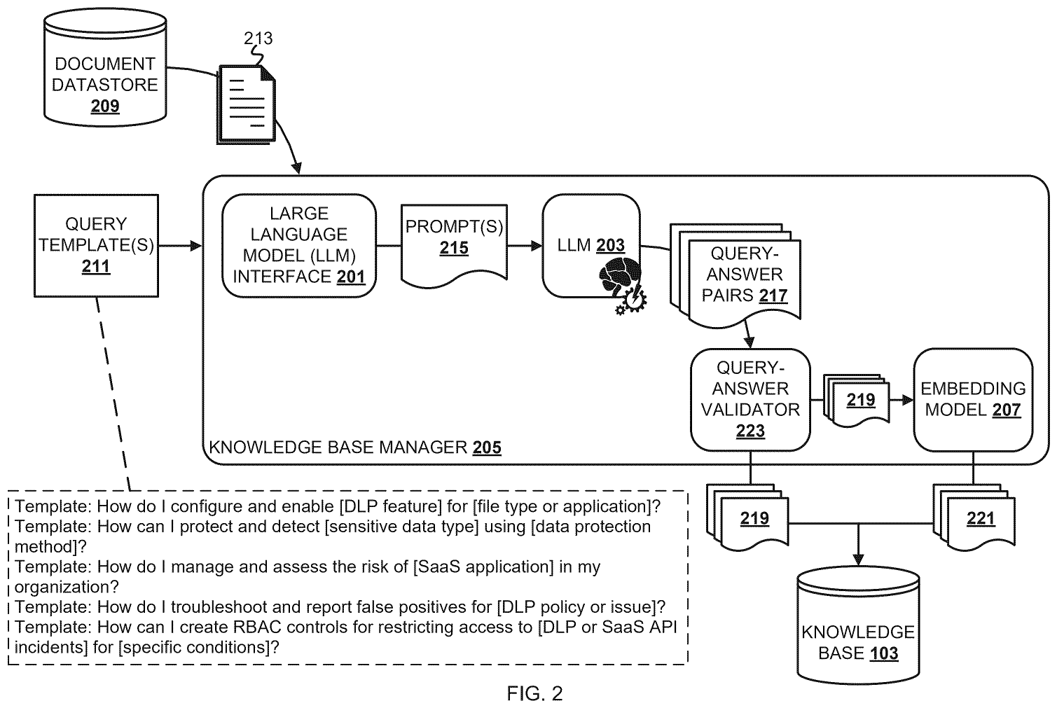

FIG. 1 depicts an example of an entry 107 of the knowledge base 103 that comprises a query-answer pair for the query, “What are some causes of IPSec VPN tunnels being down?”, which has an answer beginning with “Incorrect tunnel configuration: The IPSec VPN tunnel may not be configured correctly . . . .” The entry 107 also comprises a query embedding 109, which is an embedding of the query for causes of Internet Protocol Security (IPSec) virtual private network (VPN) tunnels being down, and indications of one or more documents 113 from which the query-answer pair was generated. The document(s) 113 can be represented with uniform resource locators (URLs) of each document. Generation of query-answer pairs based on documents to populate the knowledge base 103 will be described in further detail in reference to FIG. 2.

The client 111 submits a user query 112 to the support service 101. The user query in this example states, “What are the common causes for sites being down?” The support service 101 obtains the user query 112 and generates an embedding 115 of the user query 112 with an embedding model 105. The embedding model 105 generates embeddings from text that capture meanings of the text, such as with doc2vec, a sentence transformer, or another model and may be an off-the-shelf model, an open-source library, or the like.

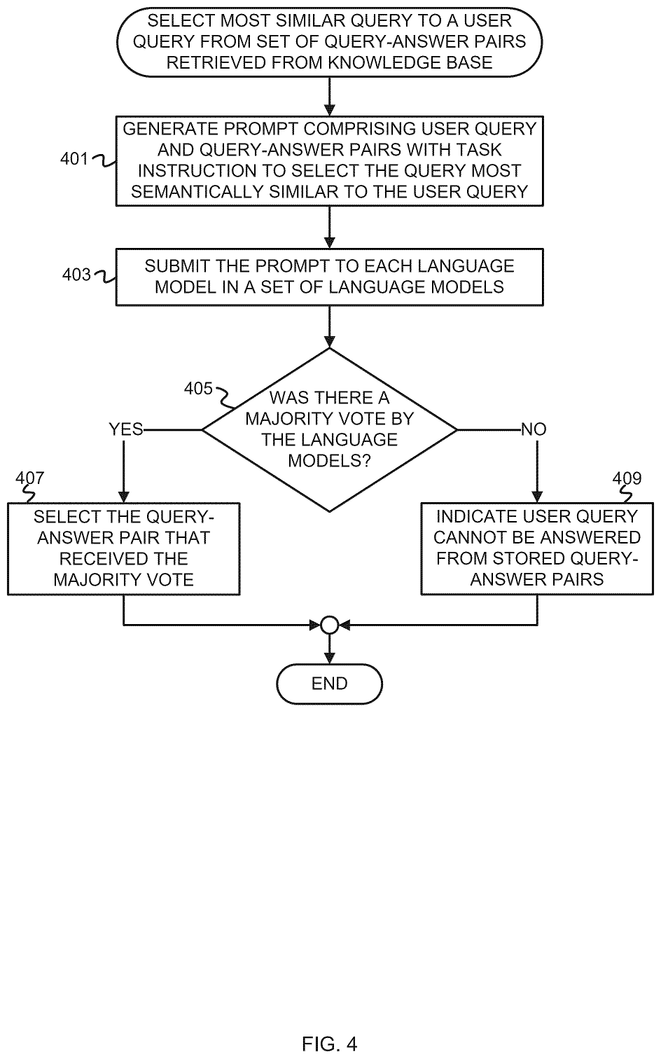

The support service 101 queries the knowledge base 103 for one or more query-response pairs maintained therein having queries that are semantically similar to the user query 112 based on the embedding 115. The support service 101 can query the knowledge base 103 with the embedding 115 to search for a top N most semantically similar query-response pairs, where N may be a parameter value provided by the support service 101. While FIG. 1 depicts an example in which N=1, an example of how the support service 101 retrieves the top N semantically similar query-response pairs from a knowledge base and generates a response based on one of the N query-response pairs when N>1 is described in reference to FIG. 4. The support service 101 can further specify a semantic similarity criterion with the embedding 115 submitted to the knowledge base so that query-response pairs are retrieved if their respective query embeddings satisfy the semantic similarity criterion relative to the embedding 115. The semantic similarity criterion can be a threshold similarity that is satisfied if the similarity between two embeddings meets or exceeds the threshold. This example assumes that the query embedding 109 in the entry 107 of the knowledge base 103 is sufficiently similar to (i.e., satisfies the semantic similarity criterion with respect to) the embedding 115. The support service 101 thus retrieves a query-answer pair 117 comprising the query and answer indicated in the entry 107 from the knowledge base 103. The query-answer pair 117 retrieved from the knowledge base 103 can also indicate the document(s) 113 (e.g., via the URL(s) of the document(s) 113).

The support service 101 generates a response 114 to the user query 112 based on the query-answer pair 117. The support service 101 generates the response 114 that comprises the answer in the query-answer pair 117. The support service 101 also includes an indication(s) of the document(s) 113 in the response. The response 114 may, for instance, indicate a link(s) to the document(s) 113 via its URL(s). The support service 101 communicates the response 114 to the client 111. The support service 101 can incorporate the indication(s) of the document(s) 113 as a link(s) in the response 114 so the user that submitted the user query 112 can navigate directly to view the document(s) 113 via the link(s).

In implementations, when there are no query-response pairs in the knowledge base 103 with respective query embeddings that are sufficiently similar to the embedding 115 according to the semantic similarity criteria used and the support service 101 thus retrieves no results from the knowledge base 103, the support service 101 can communicate a response to the client 111 indicating that the user query 112 cannot be answered. Alternatively, the support service 101 and knowledge base 103 interaction can act as a caching layer. In this example, the support service 101 can pass user queries that cannot be answered from the knowledge base 103 to another service that comprises a foundation model and uses RAG to respond to user queries.

FIG. 2 is a conceptual diagram of building a knowledge base of query-answer pairs. FIG. 2 depicts a knowledge base manager 205 that builds the knowledge base 103 of FIG. 1. The knowledge base manager 205 builds the knowledge base 103 based on documents maintained in a datastore 209 and one or more query templates 211. The datastore 209 stores documents, such as technical and/or support documents of a vendor. Documents maintained in the datastore 209 can be unstructured in format. For instance, the datastore 209 can store Portable Document Format (PDF) files, DOC files, web pages, data stored in data formats that do not have a data model or other context-based organizational structure, etc. The datastore 209 can maintain URLs of documents in association with the documents.

The knowledge base manager 205 obtains documents 213 from the datastore 209 and the one or more query templates 211 as inputs. For instance, the knowledge base manager 205 can extract text of the documents 213 as part of ingestion of the documents 213 from the datastore 209. In other examples, raw text of documents may be extracted therefrom as part of preprocessing documents for storage in the datastore 209, and the documents 213 thus comprise raw text. The one or more query templates 211 comprise one or more templates for formatting queries about content of the documents 213. FIG. 2 depicts example query templates, which include “Template: How can I protect and detect [sensitive data type] using [data protection method]?” and “Template: How do I manage and assess the risk of [SaaS application] in my organization?” Text depicted in brackets ([ ]), such as “[text_content]”, “[data protection method]”, and “[SaaS application]” in the aforementioned examples, are placeholder fields to insert text of the documents 213.

An LLM interface 201 generates one or more prompts 215 to an LLM 203 from the one or more query templates 211 that instruct the LLM 203 to generate queries and corresponding answers (or “query-answer pairs”) according to the query templates 211 based on content (i.e., text) of the documents 213. The one or more prompts 215 may, for instance, indicate text extracted from the documents 213 or links to the documents 213 for processing by the LLM 203. As another example, the LLM 203 can be provided access to the datastore 209 (e.g., via an application programming interface (API) endpoint thereof) so it can search the datastore 209 for documents when generating query-answer pairs; as a result, the one or more prompts 215 do not necessarily comprise content of the documents 213. The LLM interface 201 may be configured with a prompt template into which the one or more query templates 211 and indications of the documents 213 or content thereof are inserted. The one or more prompts 215 that the LLM interface 201 generates can comprise an instruction that designates how the LLM 203 should format its results and an instruction to indicate with each query-answer pair those of the documents 213 from which the query-answer pair was generated (e.g., by including URLs of the document(s) in the output corresponding to the query-answer pair).

The LLM interface 201 provides the one or more prompts 215 to the LLM 203, which generates query-answer pairs 217 as output. The query-answer pairs 217 comprise queries that the LLM 203 generated based on content of corresponding ones of the documents 213 and their answers determined based on those documents. The query-answer pairs 217 can also indicate the corresponding one(s) of the documents 213 that are relevant to each query-answer pair, such as by their respective URL(s). A document is relevant to a query-answer pair if the LLM 203 generated the query-answer pair based on content of the document. As another example, the LLM interface 201 can prompt the LLM 203 to generate queries according to the one or more query templates 211 and optionally can rephrase the generated queries before performing an enterprise search (e.g., with an embedding lookup) to determine the most applicable documents to each generated query. The LLM 203 (or another language model) then generates a summary of the most applicable document(s) that is included in a generated answer to the query.

A query-answer validator 223 receives query-answer pairs 217 obtained as output from prompting the LLM 203 with the one or more prompts 215. The query-answer validator 223 evaluates each query-answer pair to determine if the query and answer are valid. The query-answer validator 223 can comprise another LLM that is prompted to determine if each of the query-answer pairs 217 is valid based on one or more criteria. Example criteria for determining if a query-answer pair is valid include criteria that the query-answer pair is relevant to the corresponding one(s) of the documents 213 from which it was generated, does not include hallucinations, is accurate, etc. The query-answer validator 223 can be preconfigured with a prompt template comprising a plurality of examples of valid and invalid query-answer pairs according to the validity criteria used and inserts each of the query-answer pairs 217 into the prompt template. The prompt can also indicate criteria for scoring query-answer pairs based on the various validity criteria. Scoring criteria can indicate that the LLM should determine an aggregate score for each query-response pair based on each of the validity criteria or that the LLM should determine individual scores for each of the validity criteria (e.g., for relevancy, accuracy, presence of hallucinations, etc.). To illustrate, the query-answer validator 223 can insert each of the query-answer pairs 217 into a prompt template having the following format, where the context refers to the document(s) from which the query-answer pair was generated:

Given a question and a context, return Relevance, Accuracy, Hallucination in the JSON format. The JSON keys are as follows:

Relevance: Calculate a score (possible values: 0.0, 0.1, 0.2, 0.3, 0.4, 0.5, 0.6, 0.7, 0.8, 0.9,
1.0) that measures the relevance of the context to the question. A higher score indicates a
more relevant context.
Accuracy: Determine the likelihood (possible values: 0.0, 0.1, 0.2, 0.3, 0.4, 0.5, 0.6, 0.7,
0.8, 0.9, 1.0) that answer to questions that generate from context is correct, available, and
has details. A higher score indicates a higher chance of accuracy.
Hallucination: Determine the likelihood (possible values: 0.0, 0.1, 0.2, 0.3, 0.4, 0.5, 0.6,
0.7, 0.8, 0.9, 1.0) that the question generated from context contains hallucinated or too
broad information. A higher score indicates a higher probability of hallucination.
Example scores
Q: {{‘question’: {example_question_1}, ‘context’: {example_context_1}, ‘answer’:
{example_answer_1}}
A: {{“Relevance”: 0.9, “Accuracy”: 0.8, “Hallucination”: 0.0}}
Q: {{‘question’: {example_question_2}, ‘context’: { example_context_2}, ‘answer’:
{example_answer_2}}
A: {{“Relevance”: 0.6, “Accuracy”: 0.2, “Hallucination”: 0.0} }
Q: {{‘question’: {example_question_3}, ‘context’: {example_context_3 }, ‘answer’:
{example_answer_3}}
A: {{“Relevance”: 0.1, “Accuracy”: 0.0, “Hallucination”: 0.1}}

The subset of the query-answer pairs 217 that the query-answer validator 223 validates, depicted as query-answer pairs 219 in FIG. 2, are passed as input into an embedding model 207 that generates query embeddings 221 therefrom. The query embeddings 221 comprise natural language processing (NLP) embeddings (e.g., doc2vec embeddings, LLM embeddings, etc.) of queries in the query-answer pairs 217 that preserve semantic meaning. These NLP embeddings allow for semantic similarity search between any two queries. The query embeddings 221 generated by the embedding model 207 are provided to the knowledge base 103 for storage. The knowledge base 103 can be indexed by the query embeddings 221 for efficient retrieval of query-response pairs comprising queries semantically similar to user queries. The knowledge base 103 stores the query embeddings 221 in association with corresponding ones of the query-answer pairs 219.

Additionally, since different documents can provide answers to the same queries, the knowledge base manager 205 can verify whether any of the query embeddings 221 are similar to any query embeddings currently maintained in the knowledge base 103 before inserting the query embeddings 221 and their corresponding query-answer pairs 219 into the knowledge base. To do so, for each of the query embeddings 221, the knowledge base manager 205 searches the knowledge base 103 for query embeddings maintained therein that are similar to (e.g., based on a similarity score between embeddings exceeding a threshold or satisfying another criterion) the query embedding. For those of the query embeddings 221 that are similar to an existing query embedding in the knowledge base, the knowledge base manager 205 appends the corresponding answer from the respective one of the query-answer pairs 219 to the answer in the entry of the knowledge base 103 that contained the similar embedding rather than creating a new entry for the query-answer pair and the query embedding.

This example depicts the LLM 203 as generating query-answer pairs based on the query templates 211 and the documents 213 for simplicity. In implementations, a plurality of query templates can be provided to the LLM interface 201 for generation of prompts for corresponding subsets of documents maintained in the datastore 209. For instance, the LLM interface 201 can obtain query templates for generating queries according to one or more topics (e.g., topics corresponding to different security concerns, vendor products, etc.) that correspond to subsets of the documents 213 so that prompt generation is organized by topic. The LLM interface 201 then generates a plurality of prompts for corresponding topics (e.g., as represented by related subsets of documents in the datastore 209) and provides each of the plurality of prompts to the LLM 203 for generation of the associated query-answer pairs for each topic.

While not depicted in FIG. 2 for simplicity, validated query-answer pairs output by the query-answer validator 223 can be subject to further review and/or processing before final query-answer pairs are generated and input into the knowledge base 103 with corresponding embeddings. For instance, summaries of answers can be generated (e.g., by another LLM) that are input into the knowledge base 103 with their corresponding queries. As another example, the validated query-answer pairs can be designated for review based on domain/expert knowledge before they are input into the knowledge base.

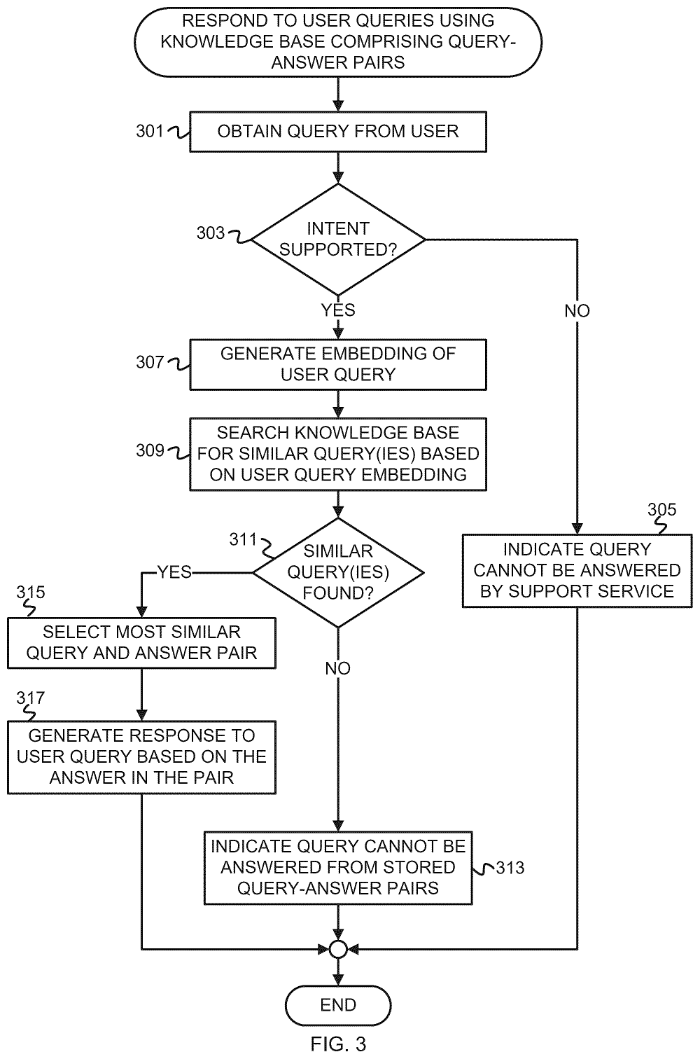

FIGS. 3-6 are flowcharts of example operations. The example operations are described with reference to a support service and a knowledge base manager for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for responding to user queries using a knowledge base that stores query-answer pairs previously generated based on a set of documents. The example operations assume that the knowledge base has been populated with query-answer pairs generated based on the documents, such as technical support documents of a vendor.

At block 301, the support service obtains a query from a user. The query can be submitted via a chatbot interface through which users can interact with the support service. The user query, which may also be referred to as an utterance. comprises natural language.

At block 303, the support service determines if an intent of the user query is supported. The support service can comprise or interact with an intent classifier that classifies intent of user queries. The intent classifier may be an LLM that has been adapted to classify intent of user queries, such as via fine-tuning, with few-shot or one-shot prompting, etc. The support service prompts the intent classifier to classify intent of the user query. Intent classification can be into one or more predetermined classes of intents that are supported or into a class indicating that the intent is unsupported, an “other” class representing unsupported queries, one or more classes that map to a category of unsupported queries, etc. In implementations, intent classification can be performed as part of preprocessing user queries before the user queries are provided to the support service for response generation. If the intent is unsupported, operations continue at block 305. If the intent is supported, operations continue at block 307.

At block 305, the support service indicates that the query cannot be answered by the support service. The support service responds to the query with a response indicating that the user's query could not be answered.

At block 307, the support service generates an embedding of the user query. The support service generates a text embedding of the user query that captures semantic meaning of the user query. The support service inputs the user query into a text embedding model (e.g., a doc2vec model, a language model pretrained to generate text embeddings, etc.) to obtain the embedding of the user query.

At block 309, the support service searches the knowledge base for one or more similar queries based on the user query embedding. The support service executes a search on the knowledge base for one or more queries that satisfy a similarity criterion indicated in the search. Similarity between the user query and queries maintained in the knowledge base can be determined based on similarities between the corresponding embeddings. For instance, the search can be for the top N queries for which a similarity between the user query embedding and the corresponding embedding of a query in the knowledge base satisfies a threshold. As another example, the search can be to identify the query having an embedding with a greatest similarity to the user query embedding (subject to a similarity threshold).

At block 311, the support service determines if a similar query(ies) could be found. A result of searching the knowledge base comprises one or more query-answer pairs for which the similarity criterion was satisfied relative to the user query or, if no queries satisfied the similarity criterion, will indicate that no queries satisfied the search criteria. If no queries satisfying the similarity criterion could be found in the knowledge base, operations continue at block 313. Otherwise, if a similar query(ies) could be found, operations continue at block 315.

At block 313, the support service indicates that the query cannot be answered from the stored query-answer pairs. The support service can respond to the user with an indication that the query could not be answered and may request that the user rephrase the query. As another example, the support service can pass the user query to a service that augments prompts to a foundation model (e.g., an LLM) with RAG to attempt to generate a response to the query with a traditional RAG approach. In the case of the latter, the knowledge base can be considered a caching layer. If the foundation model produces an answer to the user query, the query and answer can be inserted into the knowledge base along with a generated embedding of the query to facilitate future searches for similar queries.

At block 315, the support service selects a most similar query and answer pair. If the support service searched the knowledge base for the query with the greatest similarity to the user query based on the corresponding embeddings (subject to the similarity threshold), the service uses the identified query-answer pair as the most similar pair. If the support service searched the knowledge base for the top N most similar queries, the support service selects the most similar query from the top N queries. For instance, the support service can prompt a language model (e.g., an LLM) to determine the most semantically similar query among the top N queries relative to the user query. An example of selecting the most similar query from a set of N queries retrieved from the knowledge base by leveraging a set of language models is described in further detail below in reference to FIG. 4.

At block 317, the support service generates a response to the user query based on the answer in the query-answer pair. The support service generates a response that at least comprises the answer in the query-answer pair retrieved from the knowledge base selected as being most similar. The support service can also identify one or more documents that are related to the answer, such as one or more documents that are associated with the query-answer pair in the knowledge base. The document(s) may be identified by their URLs. The support service communicates the generated response to the user as a response to the query.

FIG. 4 is a flowchart of example operations for selecting a most similar query to a user query from a set of query-answer pairs retrieved from a knowledge base. The example operations assume that a set of N query-answer pairs, or candidate query-answer pairs, have been retrieved from a knowledge base based on the queries in the set being sufficiently similar to the user query. For instance, the example operations can implement block 315 of FIG. 3.

At block 401, the support service generates a prompt comprising the user query and the candidate query-answer pairs with an instruction to select the query most semantically similar to the user query. The candidate query-answer pairs can be given to each language model in the same ordering. The prompt may also specify a format for the output, such as structured data indicating the index of the query and corresponding answer selected as being most semantically similar.

At block 403, the support service submits the prompt to each language model in a set of language models. The support service submits the same prompt to multiple language models (e.g., five LLMs) and retrieves corresponding responses indicating the most semantically similar query from the set of candidate query-answer pairs.

At block 405, the support service determines if there was a majority vote by the language models. There is a majority vote by the language models if a majority of the language models (e.g., four out of five) selected a same query as having a greatest semantic similarity to the user query. The support service determines if there was a majority vote based on the results output by the language models. If there was a majority vote, operations continue at block 407. If there was not a majority vote, operations continue at block 409.

At block 407, the support service selects the query-answer pair that received the majority vote. The support service responds to the user query based on the selected query-answer pair as described in reference to FIG. 3.

At block 409, the support service indicates that the query could not be answered from the stored query-answer pairs. The support service can respond to the user query with an indication that the user query could not be answered. In other implementations, the support service can pass the query to a foundation model (e.g., an LLM) with an interface that augments prompts with RAG for generation of a response.

While FIG. 4 refers to selecting one query-answer pair based on a majority vote by a set of language models, in implementations, there may be a tie among a majority of the language models. To illustrate, given a set of five LLMs, two LLMs may select a first query-answer pair, and another two LLMs may select a second query-answer pair. To address cases where a user query may be ambiguous due to lacking specificity, the support service can select both query-answer pairs in the event of a tie among a sufficient number of language models (e.g., four out of five as in the previous example). The support service then generates a response to the user query based on both query-answer pairs, with each answer presented as a possible answer.

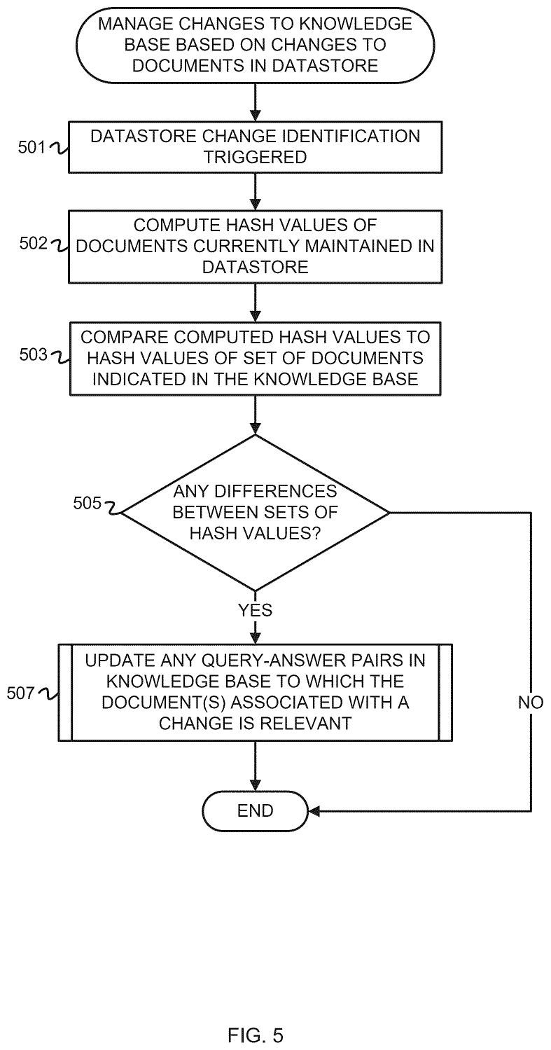

FIG. 5 is a flowchart of example operations for managing changes to a knowledge base based on changes to documents in a datastore. The datastore maintains documents based on which the knowledge base is built and maintained. Changes to documents in the datastore can include addition of new documents to the datastore, modification to documents currently maintained in the datastore, and removal (i.e., deletion) of documents from the datastore. The knowledge base indicates a set of documents based on which query-answer pairs maintained in the knowledge base were generated. For instance, each query-answer pair can indicate one or more documents (e.g., with the document URL(s)) related to the query-answer pair (i.e., used to generate the query-answer pair).

At block 501, datastore change identification is triggered. Change identification refers to identifying changes to documents maintained in the datastore. Change identification is performed periodically, such as according to a schedule (e.g., daily). Change identification may be triggered based on the knowledge base manager determining that a trigger condition has been met, based on change identification being scheduled for the current time, etc.

At block 502, the knowledge base manager computes hash values of documents currently maintained in the datastore. The knowledge base manager computes a hash value of each document maintained in the datastore. For instance, the knowledge base manager can compute a secure hash algorithm (SHA) checksum of each document maintained in the datastore.

At block 503, the knowledge base manager compares the computed hash values to hash values of the set of documents indicated in the knowledge base. The hash values of the set of documents indicated in the knowledge base can be maintained in the knowledge base (e.g., as attributes of entries corresponding to query-answer pairs and/or as indices of the knowledge base) or in a separate set of associations between documents and hash values. The knowledge base manager can compute hash values of each document indicated in the knowledge base when query-answer pairs that correspond to each document are inserted and/or updated in the knowledge base. The knowledge base manager compares the sets of hash values (e.g., the sets of SHA checksums) to identify any differences therebetween. Differences between the sets of hash values can occur if a document in the datastore has been modified since the knowledge base was updated to indicate that document and the document's hash value is thus different. Differences between the sets of hash values can also occur if a new document has been added to the datastore and the hash value of the new document thus will not have a hash value available for comparison in the set generated for documents indicated in the knowledge base. As another example, differences can occur if a document indicated in the knowledge base has been removed (i.e., deleted) from the datastore and a hash value in the set of hash values computed for documents in the knowledge base will not have a hash value available for comparison in the set generated for documents currently in the data store.

At block 505, the knowledge base manager determines if there are any differences between the sets of hash values. If any differences are identified, operations continue at block 507. Otherwise, no changes are made to the knowledge base, and operations are complete.

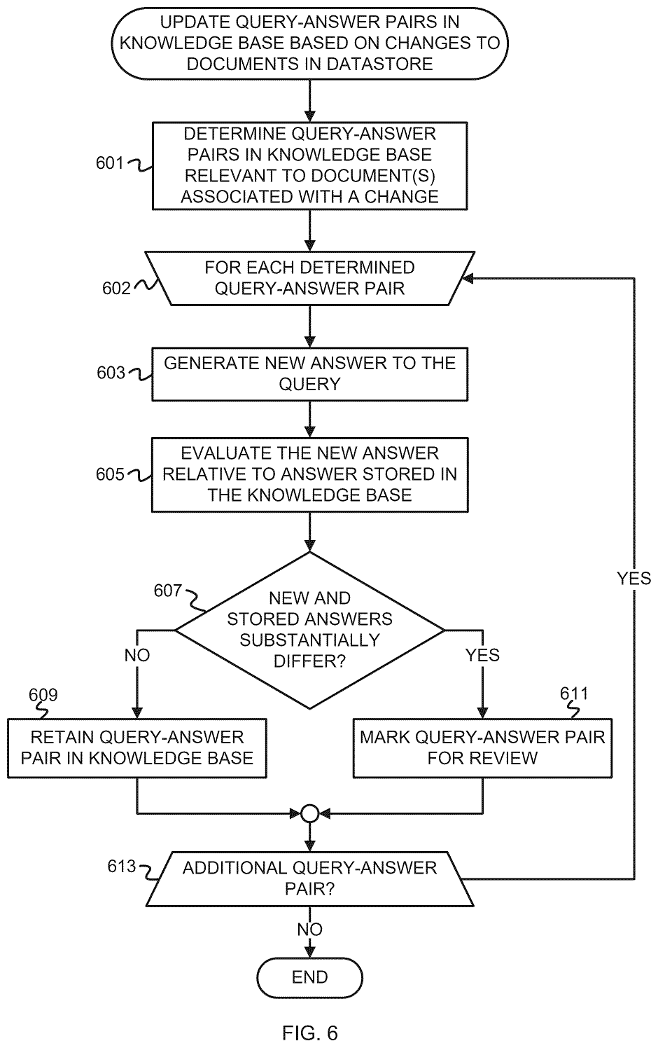

At block 507, the knowledge base manager updates the query-answer pair(s) to which the document(s) associated with a change is relevant. The knowledge base identifies the query-answer pair(s) in the knowledge base that correspond to each document associated with a change (e.g., based on searching the knowledge base for entries that indicate the document, such as by its URL). Update operations can vary in type and/or frequency depending on the type of change associated with documents (i.e., modification, deletion, or addition). For instance, updates to query-answer pairs that correspond to modified and deleted documents can be performed daily. As another example, the knowledge base manager can also periodically (e.g., weekly) determine if any new documents or modified documents can provide better answers to queries in the knowledge base than the existing answers. Updating query-answer pairs based on changes to documents in the datastore is described in further detail in reference to FIG. 6.

FIG. 6 is a flowchart of example operations for updating query-answer pairs in a knowledge base based on changes to documents in a datastore. The datastore maintains documents or indications thereof that are used to generate query-answer pairs to be stored in the knowledge base. Documents associated with a change include those that have been deleted from a datastore, those that are added to the datastore, and those that have been modified. The example operations assume that one or more documents in a datastore have been determined to be associated with a change (e.g., as described above in reference to FIG. 5).

At block 601, the knowledge base manager determines one or more query-answer pairs in the knowledge base that are relevant to one or more documents associated with a change. The knowledge base determines the query-answer pair(s) maintained in the knowledge base that are relevant to a document associated with a change based on determining the entries of the knowledge base that indicate a document that was determined to be associated with a change (e.g., an updated document or a deleted document). At block 602, the knowledge base manager begins iterating over the query-answer pairs in the knowledge base determined to be relevant to a document(s) associated with a change.

At block 603, the knowledge base manager generates a new answer to the query. To generate a new answer to the query, the knowledge base manager can prompt a language model (e.g., an LLM) that has been provided access to documents in the datastore to generate an answer based on the updated set of documents. The knowledge base manager can be configured with a prompt template for generating answers to queries in which the knowledge base manager incorporates the query, and the knowledge base manager provides the resulting prompt to the language model. The prompt template may include one or more instructions for how to select sources from the datastore and how to cite the documents that are selected.

At block 605, the knowledge base manager evaluates the new answer relative to the answer stored in the knowledge base. The knowledge base manager evaluates the new answer to determine if it significantly differs from the existing answer or, put differently, to determine if the answers are sufficiently similar to each other. The knowledge base manager can, for instance, prompt an LLM to evaluate similarity between and/or otherwise compare the two answers. The answers can be evaluated in terms of one or more qualitative aspects, such as helpfulness of the new answer, semantic similarity, the presence of hallucinations introduced in the new answer, and accuracy of the new answer, among others. The prompt that the knowledge base provides to the LLM can indicate examples of answers that substantially differ and/or are similar in one or more aspects (e.g., the aforementioned qualitative aspects). The prompt can also indicate an instruction to determine a score or other quantitative measure of similarity or dissimilarity between the answers and provide examples of scoring criteria along with examples of similar and dissimilar queries and their score(s) indicating similarity. The knowledge base manager may be configured with a prompt template in which it inserts the new answer and the existing answer before providing the prompt to the LLM.

At block 607, the knowledge base manager determines if the new and stored answers substantially differ. The knowledge base manager can determine if the answers substantially differ based on a score or other indicator of similarity or dissimilarity output by the LLM. The knowledge base manager may determine that the answers substantially differ if the score or indicator of similarity fails to satisfy a similarity criterion (e.g., a threshold) or exceeds a dissimilarity threshold, for instance. If the new and stored answers do not substantially differ, operations continue at block 609. Otherwise, operations continue at block 611.

At block 609, the knowledge base manager retains the query-answer pair in the knowledge base. Since the answer to the query generated based on the updated set of available documents did not substantially change, the original answer can remain in the knowledge base. In the case of a deleted document, the knowledge base manager can remove any reference to the deleted document in the knowledge base entry corresponding to the query-answer pair.

At block 611, the knowledge base manager marks the query-answer pair for review. Since the change to the document(s) that were used to answer the query was determined to substantially change the answer, the query-answer pair is marked for review to determine whether the query-answer pair should be updated with the new answer. The query-answer pair may be retained in the knowledge base after being marked for review and until any update thereto in the event that a user query can be answered using the query-answer pair. As with the case of query-answer pairs retained in the knowledge base, if the query-answer pair corresponds to a document that was deleted, the knowledge base manager can remove any reference to the deleted document in the knowledge base entry corresponding to the query-answer pair.

At block 613, the knowledge base manager determines if there is an additional query-answer pair in the knowledge base that is related to a document with a change. If there is an additional query-answer pair, operations continue at block 601. Otherwise, operations are complete.

FIG. 6 gives example operations for updating query-answer pairs that are potentially affected by a change to documents in the datastore. In implementations, the knowledge base manager can also periodically (e.g., weekly) determine if a new document or modified document can provide a better answer to a query maintained in the knowledge base. To do so, example operations are similar to those described in reference to FIG. 6, but the knowledge base manager iterates over each query-answer pair maintained in the knowledge base and generates a new answer for each query based on the documents maintained in the datastore (including the new and/or modified documents). As part of generating new answers for each query in the knowledge base, the knowledge base manager may generate a paraphrased representation of each query (e.g., by prompting a language model with a prompt template for paraphrasing and the query to be paraphrased) and perform an enterprise search for documents in the datastore based on the paraphrased representation of the query, wherein the result of the enterprise search yields a document(s) in the datastore from which an answer to the query is generated. The prompt template for paraphrasing can comprise instructions for a language model to capture intent of the query to be paraphrased and generate keywords from the query that are searchable in the datastore (e.g., with search engine functionality). The generated answers will also indicate the document(s) in the datastore from which the respective answer was generated. For new answers indicating at least one document that was identified as being new or modified (e.g., as described in reference to FIG. 5), the knowledge base manager then evaluates the similarity between the new answer and the existing answer for the query stored in the knowledge base as similarity described at blocks 605 and 607. If the new answer was generated based on a new and/or updated document and is not sufficiently similar to the existing answer, the query-answer pair and the new answer can be flagged for verification to determine if the knowledge base should be updated with the new answer and corresponding new/modified document(s).

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

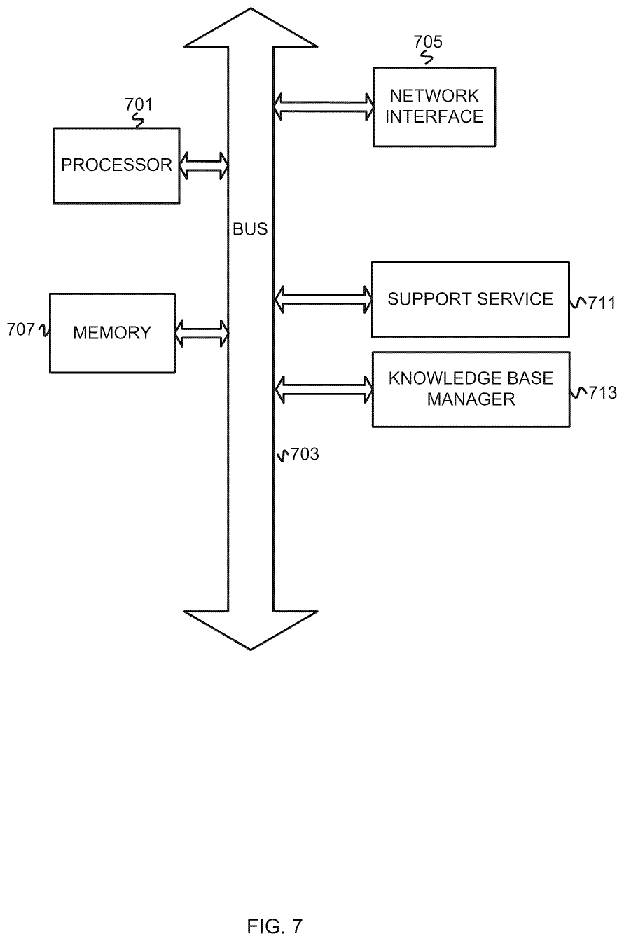

FIG. 7 depicts an example computer system with a support service and a knowledge base manager. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes support service 711 and knowledge base manager 713. The support service 711 responds to user queries based on searching a knowledge base of query-answer pairs to determine if the user query is similar to a pre-generated query with a pre-generated answer. The knowledge base manager 713 builds and maintains the knowledge base based on documents in a datastore from which query-answer pairs are generated. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on obtaining a user query, retrieving from a knowledge base a set of candidate queries that satisfy a semantic similarity criterion with respect to the user query, wherein the knowledge base comprises a plurality of queries that includes the set of candidate queries and a corresponding plurality of answers that were previously generated based on a plurality of documents;
selecting a first query from the set of candidate queries based on determining that the first query is most semantically similar to the user query from the set of candidate queries; and
generating a response to the user query based on a first answer of the plurality of answers that corresponds to the first query.

2. The method of claim 1, further comprising generating a first embedding of the user query, wherein the knowledge base also maintains a plurality of embeddings generated for the plurality of queries, and wherein retrieving the set of candidate queries comprises determining a set of the plurality of embeddings with greatest similarities to the first embedding.

3. The method of claim 1, wherein selecting the first query from the set of candidate queries comprises,
prompting a plurality of language models with the set of candidate queries and corresponding ones of the plurality of answers and a task instruction to select one of the set of candidate queries that is most semantically similar to the user query; and
selecting the first query based on determining that a majority of the plurality of language models selected the first query from the set of candidate queries.

4. The method of claim 1, wherein generating the response to the user query based on the first answer comprises generating a response to the user query that comprises the first answer and an indication of a corresponding one or more documents of the plurality of documents, wherein the corresponding one or more documents were associated with the first query and first answer in the knowledge base.

5. The method of claim 1, further comprising:
determining changes to the plurality of documents, wherein determining changes to the plurality of documents comprises determining at least one of updates to documents in the plurality of documents, addition of one or more documents to the plurality of documents, and deletion of documents in the plurality of documents; and
updating the knowledge base based on determined changes to the plurality of documents.

6. The method of claim 5, wherein updating the knowledge base comprises, based on determining that a new document has been added to the plurality of documents, generating one or more new queries and a corresponding one or more answers based, at least in part, on prompting a language model to generate queries and answers based on the new document and inserting the one or more new queries and the corresponding one or more answers to the knowledge base.

7. The method of claim 5, wherein updating the knowledge base comprises determining those of the plurality of queries that correspond to a determined change to the plurality of documents and, for each query of the plurality of queries, prompting a language model to generate a new answer to the query.

8. The method of claim 5, wherein determining changes to the plurality of documents comprises,
determining first hash values of documents indicated in the knowledge base;
determining second hash values of a current set of documents in a data store; and
comparing the first hash values and the second hash values,
wherein determining the changes to the plurality of documents is based on identifying differences between the first hash values and the second hash values.

9. The method of claim 1, further comprising populating the knowledge base with the plurality of queries and the plurality of answers based, at least in part, on the plurality of documents.

10. The method of claim 9, wherein populating the knowledge base comprises, prompting a language model to generate queries and corresponding answers based on a query template and one or more of the plurality of documents; and
inserting the queries and the corresponding answers into the knowledge base.

11. One or more non-transitory machine-readable media having program code stored thereon, the program code comprising instructions to:
maintain a knowledge base that comprises a plurality of queries and a corresponding plurality of answers, wherein the plurality of queries and the plurality of answers were previously generated based on a plurality of documents;
based on obtaining a user query, search the knowledge base to determine whether any of the plurality of queries are sufficiently similar to the user query;
determine that a first query of the plurality of queries is sufficiently similar to the user query, wherein the first query is associated with a first answer of the plurality of answers in the knowledge base; and
generate a response to the user query based on the first answer.

12. The non-transitory machine-readable media of claim 11, wherein the program code further comprises instructions to generate a first embedding of the user query, wherein the knowledge base also maintains a plurality of embeddings generated for the plurality of queries, and wherein the instructions to search the knowledge base comprise instructions to search the knowledge base for one or more of the plurality of embeddings that are sufficiently similar to the first embedding based on computed similarities between the first embedding and the plurality of embeddings.

13. The non-transitory machine-readable media of claim 11, wherein the instructions to determine whether any of the plurality of queries are sufficiently similar to the user query comprise instructions to identify a subset of the plurality of queries that satisfy a threshold similarity based on the search of the knowledge base, and wherein the instructions to determine that the first query is sufficiently similar comprise instructions to,
prompt one or more language models to select one of the subset of the plurality of queries that is most semantically similar to the user query; and
determine that the first query is sufficiently similar to the first query based on a determination that a majority of the plurality of language models selected the first query from the subset of the plurality of queries.

14. The non-transitory machine-readable media of claim 11, wherein the instructions to maintain the knowledge base comprise instructions to,
periodically determine changes to the plurality of documents, wherein the instructions to periodically determine changes to the plurality of documents comprise instructions to periodically determine at least one of updates to documents in the plurality of documents, addition of one or more documents to the plurality of documents, and deletion of documents in the plurality of documents; and
update the knowledge base based on determined changes to the plurality of documents.

15. The non-transitory machine-readable media of claim 11, wherein the instructions to generate the response to the user query based on the first answer comprise instructions to generate a response to the user query that comprises the first answer and an indication of a corresponding one or more documents of the plurality of documents, wherein the corresponding one or more documents were associated with the first query and first answer in the knowledge base.

16. An apparatus comprising:
a processor; and
a machine-readable medium having instructions stored thereon that are executable by the processor to cause the apparatus to,
based on detection of a user query, retrieve from a knowledge base a subset of a plurality of queries maintained in the knowledge base that satisfy a similarity threshold with respect to the user query, wherein the knowledge base comprises the plurality of queries and a corresponding plurality of answers that were previously generated based on a plurality of documents;
determine that a first query from the subset of queries is most semantically similar to the user query from the subset of queries; and
construct a response to the user query based on a first answer of the plurality of answers that corresponds to the first query.

17. The apparatus of claim 16, further comprising instructions executable by the processor to cause the apparatus to generate a first embedding of the user query, wherein the knowledge base also maintains a plurality of embeddings generated for the plurality of queries, and wherein the instructions executable by the processor to cause the apparatus to retrieve the subset of queries that satisfy the similarity threshold comprise instructions executable by the processor to cause the apparatus to determine a subset of the plurality of embeddings with greatest similarities to the first embedding, wherein the subset of embeddings corresponds to the subset of queries.

18. The apparatus of claim 16, wherein the instructions executable by the processor to cause the apparatus to construct the response to the user query based on the first answer comprise instructions executable by the processor to cause the apparatus to generate a response to the user query that comprises the first answer and an indication of a corresponding one or more documents of the plurality of documents, wherein the corresponding one or more documents were associated with the first query and first answer in the knowledge base.

19. The apparatus of claim 16, further comprising instructions executable by the processor to cause the apparatus to:
populate the knowledge base with the plurality of queries and the plurality of answers based, at least in part, on the plurality of documents; and
maintain the knowledge base based on changes to the plurality of documents.

20. The apparatus of claim 19, wherein the instructions executable by the processor to cause the apparatus to maintain the knowledge base based on changes to the plurality of documents comprise instructions executable by the processor to cause the apparatus to,
determine first hash values of documents indicated in the knowledge base;
determine second hash values of a current set of documents in a data store;
compare the first hash values and the second hash values; and
update the knowledge base based on identification of differences between the first hash values and the second hash values.
